(19) United States
(12) Patent Application Publication
(10) Pub. No.: US 2004/0118316 A1
(43) Pub. Date: Jun. 24, 2004

(54) Reflectorized decal for rail car

(76) Inventor: Robert S. Grandy, Hinsdale, IL (US)

Correspondence Address: EDWARD D. GILHOOLY, 28 E. JACKSON BLVD., SUITE 423, CHICAGO, IL, 60604, US

(21) Appl. No.: 10/326,780

(22) Filed: Dec. 23, 2002

(51) Int. Cl. B68G 5/00

(52) U.S. Cl. 105/157.1

(57) ABSTRACT

A reflectorized decal for a railcar being affixed to a rotating end cap roller bearing of a rail car to increase its visibility. The decal is provided with a reflectorized exterior face for reflecting light from a vehicle. Radial arms are provided on the decal to provide a propeller-like effect for enhanced visibility.

### BACKGROUND OF THE INVENTION

1. Field of the Invention

This invention relates to railcars and more specifically, to a reflector element applied to an exterior surface rotating end caps of the roller bearings of a railcar.

2. Summary of the Prior Art

To improve safety, the federal government is in the process of issuing regulations to require the use of reflective surfaces on a railcar for added safety for the operators of vehicles and pedestrians. Such reflective elements are intended to provide greater visibility of the railcar to the driver of a vehicle and the like by reflecting light from the lights of a vehicle or other light sources. A known technique for accomplishing this objective involves the placing of reflective tape along the sides of a vehicle, such as on highway trailers. This procedure of applying reflective tape requires time-consuming application of large quantities of reflective material to the railcar by workmen. The use of tape on the sidewalls of the railcar also tends to situate the reflecting surface above the normal line of vision of the operator of the vehicle along the road. In addition, stationary tape on the side of a railcar does not achieve a dynamic reflective effect to better attract the attention of a driver or individual. It is, therefore, desirable in the prior art to provide an improved device for creating a safety reflective surface on a railcar.

### SUMMARY OF THE INVENTION

It is, therefore, an objective of the invention to provide an improved means for reflecting a light source to warn individuals of the presence of a moving or stationary railcar. The reflector member of the invention is applied to rotating end cap portions of the bearing assemblies of a truck assembly of a railcar. The rotation of the reflector member on the roller bearing causes an eye catching dynamic reflection of light for greater safety during movement of the railcar. Typical roller bearings are elevated near road level so that the reflector member of the invention is better observed by a driver of a vehicle. The reflector of the invention can economically be installed and provides highly effective results in use.

### BRIEF DESCRIPTION OF THE DRAWINGS

FIG. 1 is a partial end elevational view of a roller bearing of the railroad car truck assembly having the reflectorized decal member of the invention;

FIG. 2 is an end view of the metallic locking plate of the roller bearing of FIG. 1; and

FIG. 3 is an end view of the reflectorized decal member of the invention for use on the roller bearing of FIG. 1.

### DESCRIPTION OF THE PREFERRED EMBODIMENT

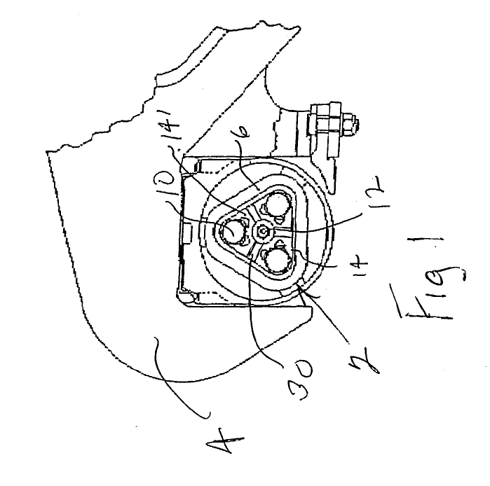

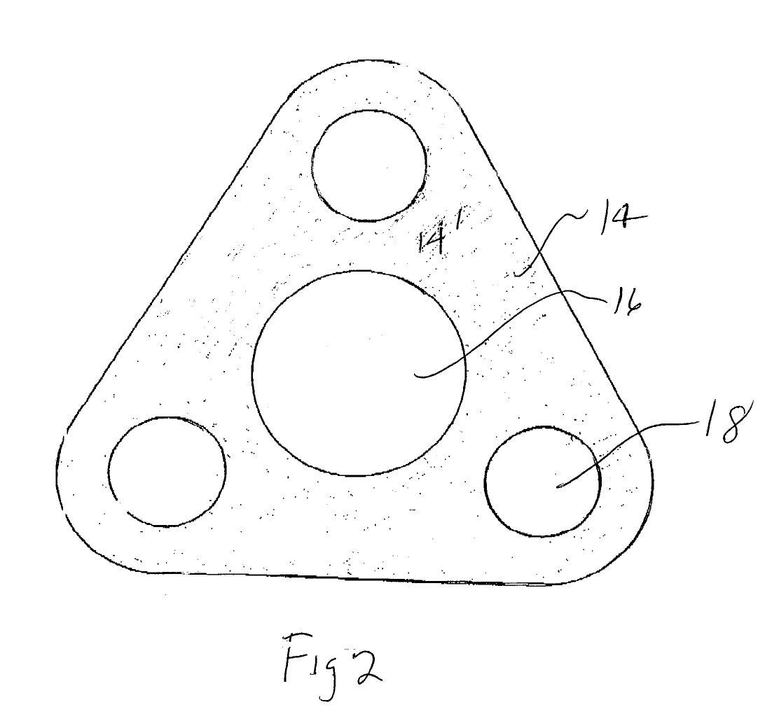

Referring to FIG. 1, there is illustrated a roller bearing 2 of the truck assembly 4 of a railcar (not shown). The roller bearing 2 is positioned at the center of the wheel (not shown) of the truck assembly 4. Generally, four bearing assemblies are present on each truck assembly having two wheels on both side ends of the railcar. The invention herein disclosed can also be used with other configurations of truck assemblies well known in the industry. In FIG. 1, roller bearing 2 includes a rotating end cap 6 affixed to a rotating axle (not shown) of the truck assembly 4 by cap screws 10. A lubricant fitting 12 for the bearings (not shown) is sometimes situated at the center of the roller bearing 2. A rotating locking plate 14 is affixed to the end cap 6 by the cap screws 10. As seen in FIG. 2, the locking plate 14 has a generally triangular configuration having a face 14′, a central opening 16 for the lubricant fitting 12 and three symmetrically arranged holes 18 for receiving the cap screws 10.

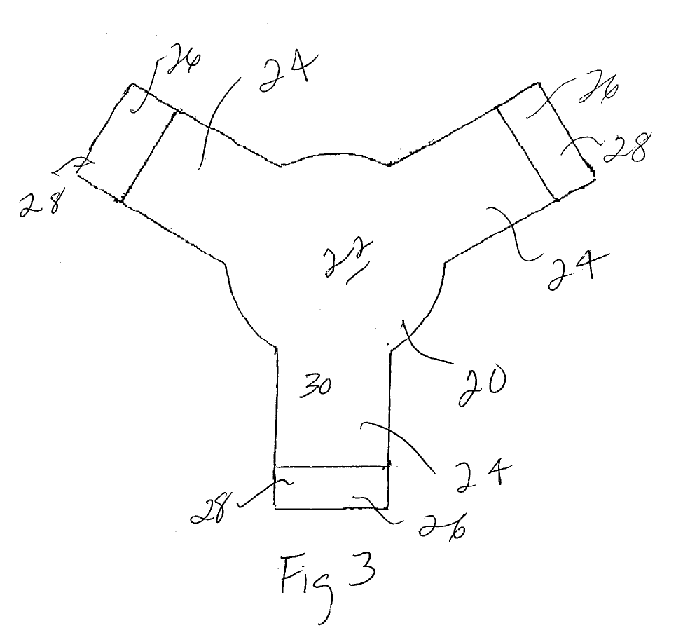

As seen in FIGS. 1 and 3, a reflectorized decal member 20 formed as a flat body that is affixed to the face 14′ of the locking plate 14 in a manner to be described. Decal member 20 may be fabricated from suitable reflective plastic or other durable and weather resistant material. The decal 20 includes a decal face 22 and three radially extending reflective arms 24 that extend from central portion 22. The ends 28 of the arms 24 have respective end portions 26 which are bent over the locking plate 14 when affixed to face 14′ of locking plate 14 to achieve a mechanical attachment During movement of the railcar, the locking plate 14 rotates with the end cap 6 so that the reflective radial arms 24 produce a propeller-like effect when light is directed to the decal face 22 to enhance visibility. The face 22 including arms 24 of the decal member 20 is provided with a reflectorized surface 30 that it reflects light from the headlights of a vehicle or other source of light. Any conventional type of reflector surface or material that reflects light well known in the industry may be used on the exposed face 22 of the reflector member 20. Although not intended to be so limited, the reflector surface may be composed of prismatic surfaces having a minimum of 600 candlepower reflectivity and able to reflect light from vehicle head lights at angles up to 90°. The decal 20 may be white, yellow, or other suitable color.

The reflector decal member 20 may be provided with a back surface (not shown) having a heavy-duty self-adhesive for adherence to the locking plate 14. The decal 20 may be affixed by applying a liquid adhesive to the back surface during application of the member 20 on the locking plate 14 in a conventional manner. It is also within the scope of the invention to apply a liquid reflectorized material of a known type directly to the locking plate 14 which dries into a permanent reflector surface. Although the decal member 20 is shown having radial arms 24 in FIGS. 1 and 3, the actual configuration of reflector face 22 may cover all of the exposed face 14′ of the locking plate 14 or may partially cover face 14′ with other symmetrical or non-symmetrical configurations.

What is claimed is:

1. A reflectorized railcar having a plurality of truck assemblies comprising
a roller bearing of one of the plurality of truck assemblies,
said roller bearing having a locking plate, said locking plate having exterior face, and
reflector means affixed to said exterior face of said locking plate for reflecting light directed to said face.

2. The railcar according to claim 1 wherein said reflector means is affixed to said face by an adhesive.

3. The railcar according to claim 2 wherein said reflector means includes a plurality of radially extending arms, said arms having exterior reflector surface.

4. The railcar according to claim 1 wherein said exterior face of said locking plate is rotating during movement of the railcar.

5. A reflector for a rotating wheel bearing of a railcar comprising
a flat member having an exterior face and a back surface,
at least a portion of said exterior face having a light reflecting surface and said back surface being arranged to be affixed to a portion of the wheel bearing.

6. The reflector according to claim 5 wherein said portion of the wheel bearing rotates during movement of the railcar.

7. The reflector according to claim 5 wherein said member has a plurality of radial arms having light reflecting exterior surfaces.

8. The reflector according to claim 5 wherein said flat member is a decal.
